(19) United States
(12) Patent Application Publication
(10) Pub. No.: US 2026/0131485 A1
(43) Pub. Date: May 14, 2026

(54) GRIPPING DEVICE AND CONVEYANCE SYSTEM BACKGROUND OF THE INVENTION

(71) Applicant: NEC Corporation, Minato-ku, Tokyo (JP)

(72) Inventors: Masatsugu OGAWA, Tokyo (JP); Tatsuhiko NAKABAYASHI, Tokyo (JP); Hiromi MUTO, Tokyo (JP); Hidekazu NAGAOKA, Tokyo (JP); Rieko UENO, Tokyo (JP); Takayuki OKADA, Tokyo (JP); Takuma WADA, Tokyo (JP); Natsumi YAMASAKI, Tokyo (JP)

(73) Assignee: NEC Corporation, Minato-ku, Tokyo (JP)

(21) Appl. No.: 19/119,439

(22) PCT Filed: Oct. 26, 2022
(86) PCT No.: PCT/JP2022/039966

§ 371 Date: Apr. 9, 2025

(51) Int. Cl. B25J 15/06; B25J 9/16

(52) U.S. Cl. CPC B25J 15/0625; B25J 9/1612

(57) ABSTRACT

This gripping device comprises a hand part that grips an object, and an arm part that is connected to the hand part and moves the hand part, wherein hand part includes a suction section that has a suction surface sucking the object, and a support section that is movable along the suction surface relative to the suction section.

### TECHNICAL FIELD

The present invention relates to a gripping device and a conveyance system.

### BACKGROUND ART

Patent document 1 below discloses a conveying device that has a gripping unit that grips at least one of packages stacked on a placement section, and a support section that supports a package moved by the gripping unit from below, and removes the package from the placement section.

### PRIOR ART DOCUMENTS

### Patent Document

Patent document 1: Japanese Unexamined Patent Application, First Publication No. 2022-105537

### SUMMARY OF INVENTION

### Problems to be Solved by the Invention

In the above-mentioned conveying device, first, the support section is moved to the front of the placement section and left on standby, and then the gripping unit grips the package on the placement section and pulls the package (movement in the negative X-axis direction), thereby placing the package on the standby support section.

In this way, in the above-mentioned conveying device, the gripping unit and the support section have separate drive systems, and the device configuration is large, so that, for example, when the gap between the shelf and the package is narrow and the package is lined up with no gaps, it may be difficult to pick up the package.

An example object of the present invention is to provide a gripping device and conveyance system that solves the above problems.

### Means for Solving the Problem

In order to solve the above problems, the present invention proposes the following configuration.

The gripping device shown in the present invention includes: a hand part that grips an object, and an arm part that is connected to the hand part and causes the hand part to move, wherein the hand part includes a suction section that has a suction surface, and a support section that can move relative to the suction section along the suction surface.

The conveyance system shown in the present invention includes the gripping device and a control device that controls the gripping device, wherein the control device has a first operation mode in which, while the suction section is moved in a first direction along the suction surface while sucking an object, the support section is moved relatively in a direction opposite to the first direction to place the target object on the support section.

### Effects of Invention

According to the present invention, a gripping device and conveyance system capable of picking up an object can be provided with a compact device configuration.

### BRIEF DESCRIPTION OF THE DRAWINGS

FIG. 1 is a configuration diagram of a gripping device according to a minimum configuration example of the present invention.

FIG. 2 is a configuration diagram of a conveyance system including a gripping device according to a first example embodiment.

FIG. 3 is a side view of the gripping device according to the first example embodiment.

FIG. 4 is a plan view of the gripping device according to the first example embodiment.

FIG. 5 is a plan view of a gripping device according to a modified example of the first example embodiment.

FIG. 6 is a plan view of a gripping device according to another modified example of the first example embodiment.

FIG. 7 is an explanatory diagram illustrating a pick-up operation of the conveyance system according to the first example embodiment.

FIG. 8 is an explanatory diagram illustrating the pick-up operation of the conveyance system according to the first example embodiment.

FIG. 9 is an explanatory diagram illustrating the pick-up operation of the conveyance system according to the first example embodiment.

FIG. 10 is an explanatory diagram illustrating a release operation of the conveyance system according to the first example embodiment.

FIG. 11 is an explanatory diagram illustrating the release operation of the conveyance system according to the first example embodiment.

FIG. 12 is an explanatory diagram illustrating the release operation of the conveyance system according to the first example embodiment.

FIG. 13 is an explanatory diagram illustrating the release operation of the conveyance system according to the first example embodiment.

FIG. 14 is a side view of a gripping device according to a second example embodiment.

FIG. 15 is an explanatory diagram illustrating a pick-up operation of the conveyance system according to the second example embodiment.

FIG. 16 is an explanatory diagram illustrating a pick-up operation of the conveyance system according to a third example embodiment.

FIG. 17 is an explanatory diagram illustrating the pick-up operation of the conveyance system according to the third example embodiment.

FIG. 18 is an explanatory diagram illustrating the pick-up operation of the conveyance system according to the third example embodiment.

### EXAMPLE EMBODIMENTS

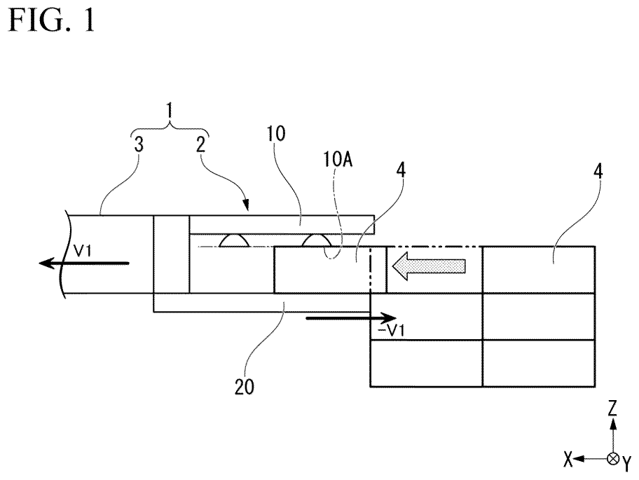

An example of the minimum configuration of the present invention will be described with reference to FIG. 1.

FIG. 1 is a configuration diagram of a gripping device 1 according to a minimum configuration example of the present invention.

As shown in FIG. 1, the gripping device 1 includes a hand part 2 that grips a target object 4, and an arm part 3 that is connected to the hand part 2 and causes the hand part 2 to move.

In the following description, an XYZ Cartesian coordinate system is set, and the positional relationship of each member is described with reference to this XYZ Cartesian coordinate system. The X-axis direction is a first direction (also called the front-back direction) in which the gripping device 1 accesses the target object 4. The Y-axis direction is a second direction (also called the left-right direction) that is perpendicular to the first direction. The Z-axis direction is a height direction (also called the up-down direction). The first and second directions may be horizontal directions.

The hand part 2 includes a suction section 10 that has a suction surface 10A, and a support section 20 that can move relative to the suction section 10 along the suction surface 10A. The support section 20 may be relatively movable in a direction parallel to the suction surface 10A. The suction section 10 is connected to the arm part 3 and moves together with the arm part 3. The suction section 10 is formed in a flat plate shape and has the suction surface 10A on its lower surface side that sucks the target object 4.

The support section 20 is disposed with a gap between it and the suction surface 10A. The support section 20 is formed in a flat plate shape and is connected to the arm part 3 so as to be movable relative to the suction section 10 along the suction surface 10A. The support section 20 is movable in the connection direction between the hand part 2 and the arm part 3 (the X-axis direction in the example of FIG. 1), between a facing position where its upper surface faces the suction surface 10A and a non-facing position where its upper surface does not face at least a part of the suction surface 10A.

The suction surface 10A is typically within the range of the outer shape of the suction section 10 in a plan view, but is essentially within the outermost range of the underside of the suction section 10 where suction force is exerted. For example, when multiple suction pads are arranged on the underside of the suction section 10, the range where suction force is exerted can be defined as the area surrounding all of the suction pads in a planar view.

According to the above configuration, as shown in FIG. 1, even if the arm part 3 moves the target object 4 back in the X-axis direction while the suction section 10 is sucking the target object 4 (operating at a speed of +V1), by performing an operation of moving the support unit 20 relatively forward (operating at a speed of −V1), the absolute position of the support section 20 does not change, and the standby state in front of the target object 4 can be maintained. In other words, the support section 20 can be made to wait in front of the target object 4 and pick up the target object 4 while supporting it from below, without having to move the suction section 10 and the support section 20 separately and independently by providing two arm parts 3.

In this way, the gripping device 1 according to the above-mentioned minimum configuration can consolidate the arm part 3 into one, and pick up the target object with a compact device configuration.

In addition, the conveyance system according to the minimum configuration also has a first operation mode in which, while the suction section 10 is moved in a first direction (+X direction) along the suction surface while sucking the target object 4, the support section 20 is moved relatively in the opposite direction (−X direction) to the first direction to place the target object 4 on the support section 20. Therefore, even if the arm part 3 is consolidated into one, the support section 20 can be made to wait in front of the target object 4, and the target object can be picked up with a compact device configuration.

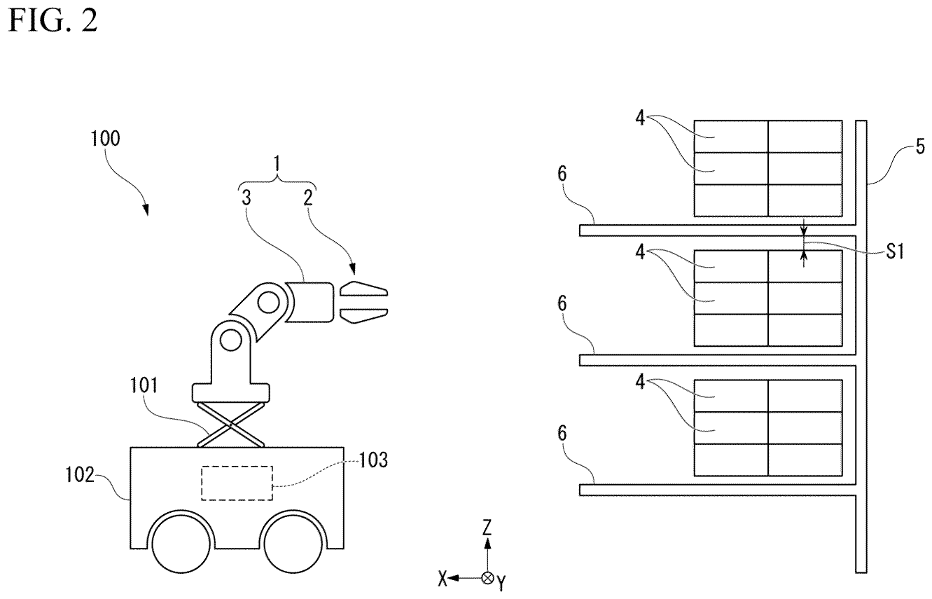

Each example embodiment of the present invention will be described with reference to FIG. 2 to FIG. 18. In FIG. 2 to FIG. 18, the same reference numerals are used for the components common to FIG. 1, and the description will be simplified.

### First Example Embodiment

FIG. 2 is a configuration diagram of a conveyance system 100 including a gripping device 1 according to the first example embodiment.

The conveyance system 100 shown in FIG. 2 picks up a specified target object 4 from a rack 5 on which the target objects 4 are stacked, and conveys it to a specified location. Note that the specified target object 4 is typically a box (such as a cardboard box) in which a product or the like is packed, but is not limited to such a box as long as it can be sucked.

In the example shown in FIG. 2, the rack 5 has multiple shelves 6 spaced apart in the height direction (Z-axis direction), and a gap S1 between a shelf 6 and the target object 4 stacked on the shelf 6 below is narrow. The gap S1 is, for example, a gap large enough for at least the palm of an adult male's hand to be inserted, and is, for example, 10 cm or less, more specifically, about 2 cm to 5 cm.

The arm part 3 is, for example, a multi-joint robot arm. The arm part 3 is preferably, for example, a six-axis robot arm that can move around the X-axis, Y-axis, Z-axis, and each of the axes. The arm part 3 is mounted on an autonomous mobile cart 102 via a lifter 101. Note that the lifter 101 may or may not be installed depending on the height of the rack 5.

The autonomous mobile cart 102 moves, for example, along the floor surface on which the rack 5 is installed. The autonomous mobile cart 102 is equipped with a control device 103. The control device 103 controls the operation of the gripping device 1, the lifter 101, and the autonomous mobile cart 102. The control device 103 also communicates with a higher-level system (not shown) (for example, a Warehouse Management System (WMS)) to, for example, receive designation of the target object 4 to be picked up (identification information, storage location, dimensions, weight, etc.), and also feeds back results such as success or failure in picking up the target object 4.

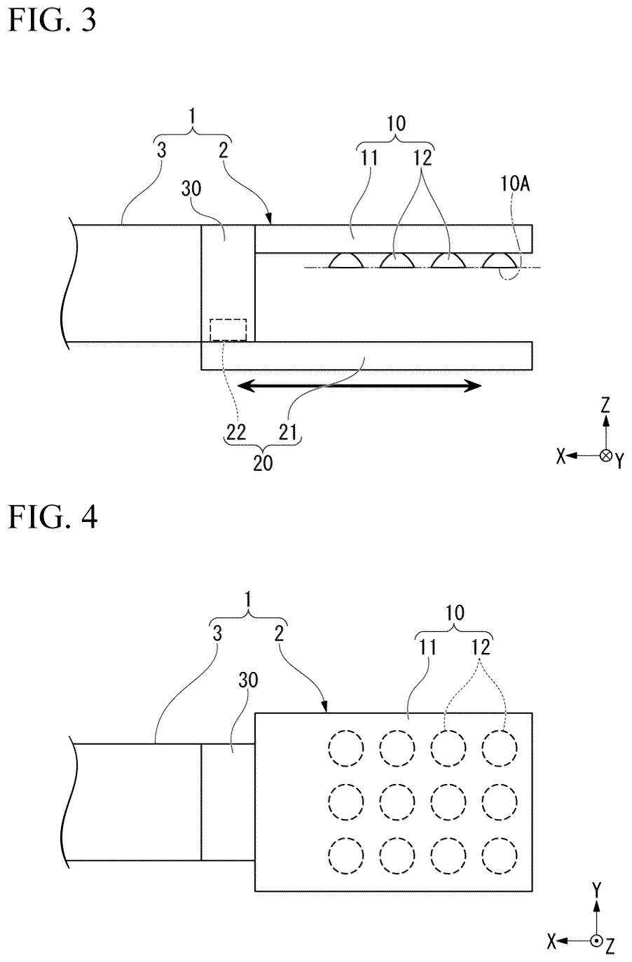

FIG. 3 is a side view of the gripping device 1 according to the first example embodiment. FIG. 4 is a plan view of the gripping device 1 according to the first example embodiment.

As shown in these figures, the gripping device 1 comprises; a hand part 2 that grips the target object 4, and an arm part 3 that is connected to the hand part 2 and causes the hand part 2 to move. At least one of the hand part 2 and the arm part 3 may be equipped with a camera (not shown) to detect the target object 4.

The hand part 2 includes; a suction section 10 that has a suction surface 10A, a support section 20 that can move relative to the suction section 10 along the suction surface 10A, and a connection section 30 that detachably connects the suction section 10 and the support section 20 to the tip of the arm part 3. The support section 20 may be relatively movable in a direction parallel to the suction surface 10A. The hand part 2 can be attached to the arm part 3 by the connection section 30 depending on, for example, the height, width, and depth dimensions of the target object 4.

The suction section 10 includes; a first flat plate 11 and a plurality of suction pads 12 (suction mechanism) provided on the lower surface of the first flat plate 11. The first flat plate 11 is a flat plate member that has a certain thickness, and has a rectangular shape with the X-axis direction being long in a plan view as shown in FIG. 4. The plurality of suction pads 12 are arranged in a matrix state at equal intervals on the lower surface of the first flat plate 11. The arrangement and number of the suction pads 12 are not limited to those shown in FIG. 4.

The suction pads 12 are suction cup-shaped, and their lower surfaces are the suction parts. The suction surface 10A is formed by the lower surfaces of the plurality of suction pads 12. Instead of the suction pads 12, the lower surface of the first flat plate 11 may be provided with a plurality of suction holes, and the lower surface of the first flat plate 11 itself may be the suction surface 10A. The thickness dimension of this suction section 10 (the dimension from the upper surface of the first flat plate 11 to the suction surface 10A) should be equal to or smaller than the gap S1 shown in FIG. 2.

As shown in FIG. 3, the support section 20 includes a second flat plate 21 and a slide mechanism 22 that slides the second flat plate 21 along the suction surface 10A. The second flat plate 21, like the first flat plate 11, is a flat plate member that has a certain thickness, and has a rectangular shape with the X-axis direction being longer in a plan view. The shape of the second flat plate 21 does not necessarily have to match or be similar to that of the first flat plate 11. For example, the second flat plate 21 may be a fork shape with a gap so that it does not interfere (clash) with the connection section 30 when it slides toward the connection section 30.

The slide mechanism 22 moves the second flat plate 21 in the connecting direction between the hand part 2 and the arm part 3 (the X-axis direction in the example shown in FIG. 3). The slide mechanism 22 has, for example, a rack and pinion mechanism, and moves a rack (not shown) formed on the second flat plate 21 side by, for example, a pinion (not shown) connected to a motor arranged in the connection section 30. Furthermore, the slide mechanism 22 may be a ball screw mechanism, a cylinder mechanism, or other mechanisms.

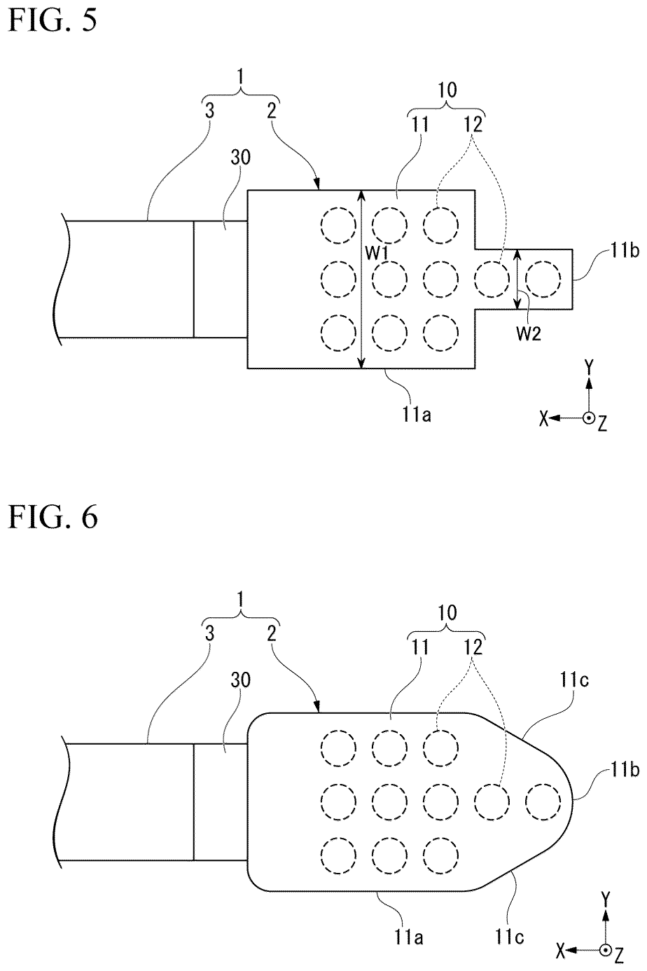

FIG. 5 is a plan view of the gripping device 1 according to a modified example of the first example embodiment.

As shown in FIG. 5, the first flat plate 11 of the suction section 10 (as well as the second flat plate 21 of the support section 20) may have a tip portion 11b with a narrower width than the other portion (main body section 11a). Specifically, a main body portion 11a of the first flat plate 11 on the connection section 30 side has a width W1 in the Y-axis direction. Furthermore, the tip portion 11b of the first flat plate 11 has a width W2 in the Y-axis direction. This makes it easier to insert the tip of the hand portion 2 into a narrow gap.

FIG. 6 is a plan view of the gripping device 1 according to another modified example of the first example embodiment.

As shown in FIG. 6, the corners of the first flat plate 11 of the suction section 10 (as well as the second flat plate 21 of the support section 20) may be rounded. Specifically, the corners of the first flat plate 11 are arc-shaped in plan view. In addition, the step between the main body part 11a and the tip part 11b (see FIG. 5) is a tapered section 11c (see FIG. 6), and the main body part 11a and the tip part 11b are smoothly connected. This makes it easier for the gripping device 1 to work in cooperation with a person.

Next, the operation of the conveyance system 100 (gripping device 1) configured as described above will be described. In the following description, unless otherwise specified, the control device 103 shown in FIG. 2 mainly controls the following operations.

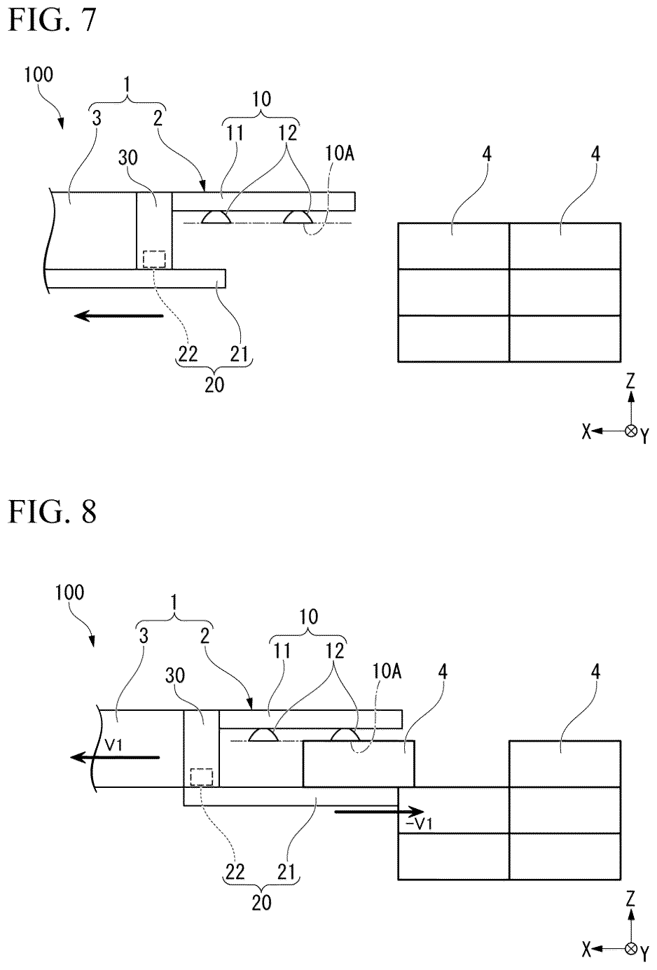

FIG. 7 to FIG. 9 are explanatory diagrams illustrating the pickup operation of the conveyance system 100 according to the first example embodiment.

As shown in FIG. 7, when picking up the target object 4 arranged at the front and top, then at first, the support section 20 is retracted. Specifically, the second flat plate 21 is slid in the +X direction by the slide mechanism 22.

Next, the suction section 10 is inserted into the space above the target object 4, and the upper surface of the target object 4 is sucked onto the suction surface 10A. After that, as shown in FIG. 8, the arm part 3 is retracted to pull out the target object 4 from above the other target objects 4, and the support section 20 is moved forward relatively, and the support section 20 waits in labor the target object 4, and the pulled out target object 4 is placed on the support section 20.

To explain this operation in detail, first, the suction section 10 is advanced by the arm part 3, and the suction section 10 is inserted into the space above the target object 4. Thereafter, the suction section 10 is moved slightly downward by the arm part 3, so that the suction surface 10A comes into contact with the upper surface of the target object 4. In this state, the upper surface of the target object 4 is sucked to the lower surface of the suction pad 12.

Then, while the suction section 10 is being moved in a first direction (+X direction) along the suction surface 10A by the arm part 3, with the target object 4 being sucked by the suction section 10, the support section 20 is moved relatively in a direction opposite to the first direction (−X direction), and the target object 4 is pulled out, and the target object 4 is placed on the support section 20. The control device 103 has an operation mode (first operation mode) that executes such a characteristic operation.

In this first operation mode, while the suction section 10 is moved in the first direction (+X direction) along the suction surface 10A while sucking the target object 4, the control device 103 moves the support section 20 in the opposite direction (−X direction) to the first direction and at the same speed (speed V1, speed −V1) relative to the suction section 10, to thereby place the target object 4 on the support section 20. In this operation mode, from the outside, the support section 20 appears to be stationary and waiting in front of the target object 4.

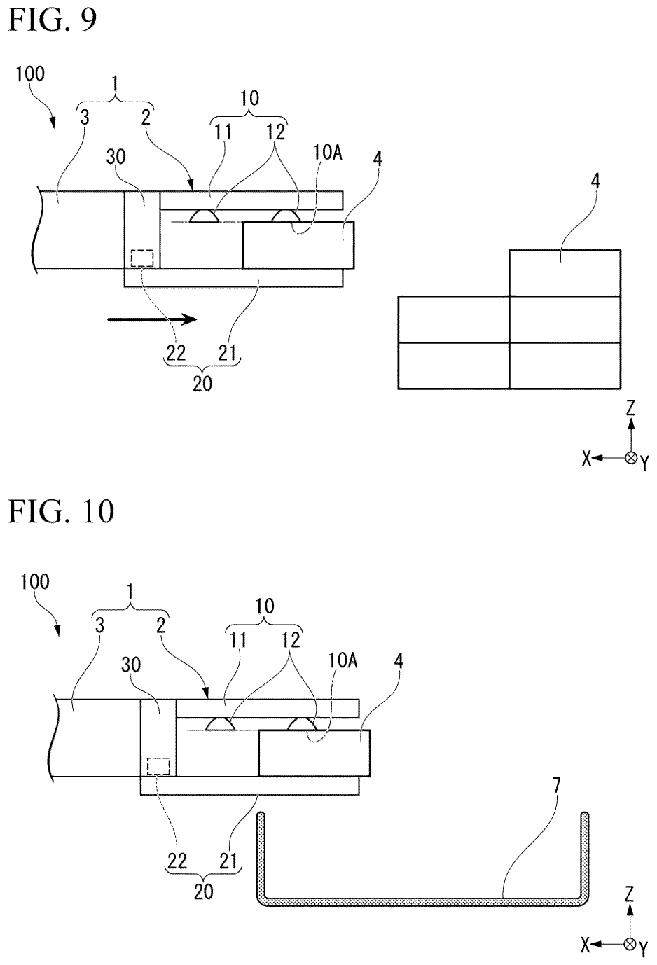

Next, as shown in FIG. 9, the support section 20 is moved forward to support the target object 4 sucked by the suction section 10 at a predetermined position. Specifically, the second flat plate 21 is slid in the-X direction by the slide mechanism 22. As a result, the target object 4 is gripped between the suction section 10 and the support section 20.

This completes the pickup operation of the target object 4.

FIG. 10 to FIG. 13 are explanatory diagrams illustrating the release operation of the conveyance system 100 according to the first example embodiment.

As shown in FIG. 10, when releasing the target object 4 onto the tray 7, first, the arm part 3 moves the target object 4 onto the tray 7. The tray 7 may be installed in the same designated location in the warehouse as the rack 5, or may be mounted on the autonomous mobile cart 102.

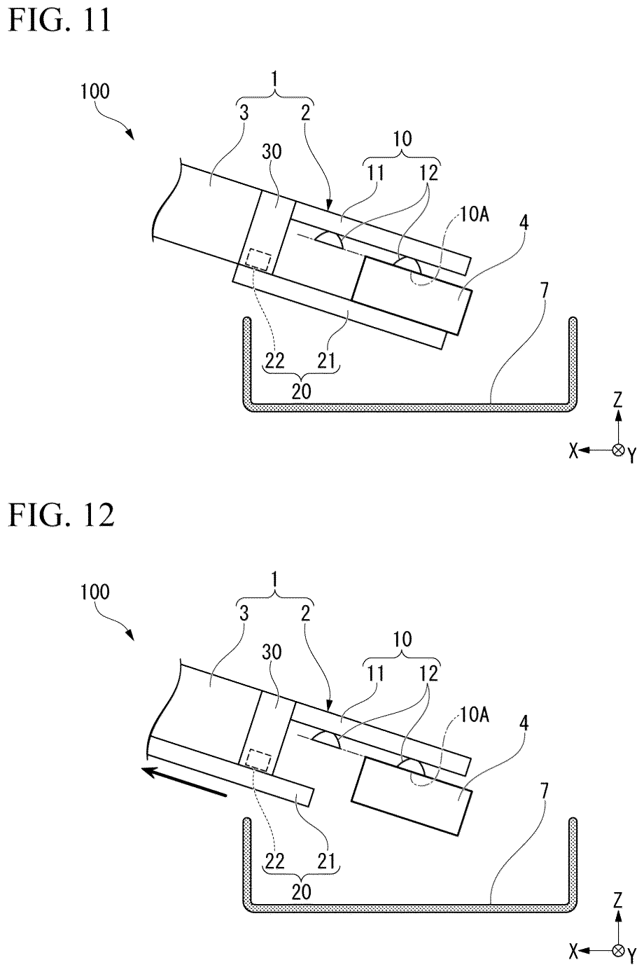

Next, as shown in FIG. 11, the arm part 3 inserts the hand part 2 at an angle so as not to interfere with the tray 7. The insertion angle of the hand part 2 may be adjusted according to the height of the edge of the tray 7.

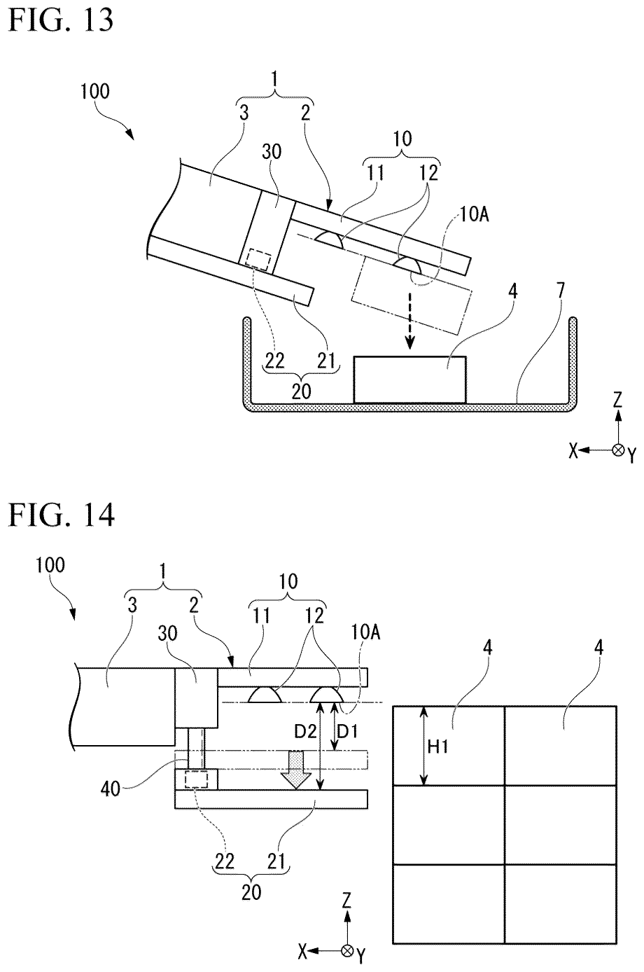

Next, as shown in FIG. 12, the support section 20 is moved back above the tray 7. After that, as shown in FIG. 13, the suction by the suction section 10 is released, so that the picked up target object 4 can be released onto the tray 7.

This completes the release operation of the target object 4.

As such, the gripping device 1 of this example embodiment described above includes a hand part 2 that grips a target object 4, and an arm part 3 that is connected to the hand part 2 and causes the hand part 2 to move. The hand part 2 includes a suction section 10 that has a suction surface 10A, and a support section 20 that can move relative to the suction section 10 along the suction surface 10A. The support section 20 may be movable relatively in a direction parallel to the suction surface 10A. With this configuration, the arm part 3 is consolidated into one, and the target object can be picked up with a compact device configuration.

Furthermore, in this example embodiment, at least one of the suction section 10 and the support section 20 is flat. With this configuration, it becomes easier to insert the hand part 2 into a narrow gap S1 as shown in FIG. 2.

Also, in this example embodiment, as shown in FIG. 5, at least one of the suction section 10 and the support section 20 may be flat, with the tip part 11b having a narrower width than the other part (main body part 11a). This configuration makes it easier to insert the hand part 2 into a narrow gap.

Also, in this example embodiment, as shown in FIG. 6, at least one of the suction section 10 and the support section 20 may be flat, with rounded corners. This configuration makes it easier for the gripping device 1 to work in cooperation with a person.

The conveyance system 100 of this example embodiment also includes the gripping device 1 and a control device 103 that controls the gripping device 1. The control device 103 has a first operation mode in which, while the suction section 10 is moved in a first direction along the suction surface 10A with the target object 4 being suctioned, the support section 20 is moved relatively in a direction opposite to the first direction to place the target object 4 on the support section 20 (see FIG. 8). With this configuration, even if the arm part 3 is consolidated into a single arm, the support section 20 can be made to wait in front of the target object 4, and the target object can be picked up with a compact device configuration.

Furthermore, in this example embodiment, in the first operating mode, while moving the suction section 10 in the first direction (+X direction) along the suction surface 10A while sucking the target object 4, the control device 103 moves the support section 20 in the opposite direction to the first direction (−X direction) relative to the suction section 10 at a speed equal to that of the suction section 10, thereby placing the target object 4 on the support section 20. With this configuration, the absolute position of the support section 20 does not change during the pulling operation of the suction section 10, and the standby state in front of the target object 4 can be maintained, so that the target object can be picked up reliably.

### Second Example Embodiment

Next, a second example embodiment of the present invention will be described. In the following description, the same reference numerals are used for the same or equivalent configurations as those in the above-mentioned example embodiment, and the description thereof will be simplified or omitted.

FIG. 14 is a side view of the gripping device 1 according to the second example embodiment.

As shown in FIG. 14, in the second example embodiment, the hand part 2 differs from the above example embodiment in that it includes a gap adjustment unit 40 that adjusts the gap between the suction section 10 and the support section 20 in a direction perpendicular to the suction surface 10A (the Z-axis direction in the example of FIG. 14).

The gap adjustment unit 40 is provided, for example, on the connection section 30, and moves the attachment portion of the suction section 10 of the connection section 30 closer to or farther from the attachment portion of the support section 20 of the connection section 30 (including the slide mechanism 22). Note that in the example of FIG. 14, the gap adjustment unit 40 moves the attachment portion of the support section 20 of the connection section 30 up and down, but it may also move the attachment portion of the suction section 10 of the connection section 30 up and down. Examples of this gap adjustment unit 40 include a rack and pinion mechanism, a ball screw mechanism, and a cylinder mechanism.

The gripping device 1 configured as above can adjust the distance between the suction section 10 and the support section 20 before the suction section 10 sucks the target object 4. For example, if the distance D1 between the suction surface 10A of the suction section 10 and the upper surface of the second flat plate 21 of the support section 20 is smaller than the height dimension H1 of the target object 4, the distance adjustment unit 40 can adjust the distance to a distance D2 that is equal to or larger than the height dimension H1. The control device 103 has an operation mode (third operation mode) that executes such a characteristic operation.

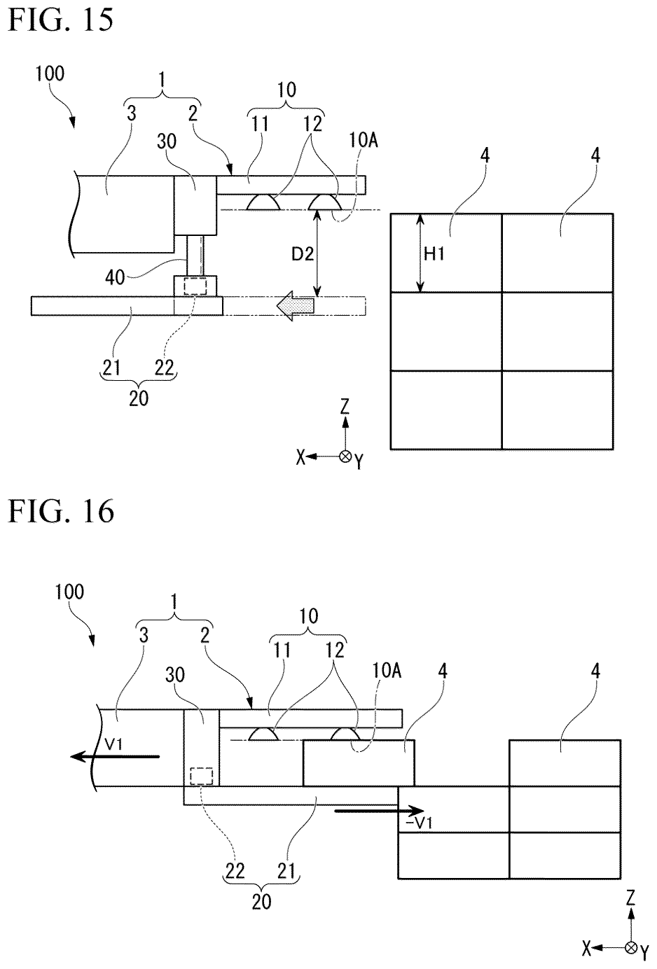

FIG. 15 is an explanatory diagram illustrating the pickup operation of the conveyance system 100 according to the second example embodiment.

As shown in FIG. 15, when picking up the target object 4 placed at the front and top, the distance between the suction section 10 and the support section 20 is adjusted by the distance adjustment unit 40, and then the support section 20 is retracted. The subsequent operation is as shown in FIG. 8 and FIG. 9 described above.

In this way, in the gripping device 1 of the second example embodiment, the hand part 2 is provided with a distance adjustment unit 40 that adjusts the distance between the suction section 10 and the support section 20, in a direction perpendicular to the suction surface 10A. With this configuration, the distance between the suction section 10 and the support section 20 can be adjusted according to the height dimension of the target object 4.

In addition, the conveyance system 100 of the second example embodiment is provided with the above-mentioned gripping device 1 and a control device 103 that controls the gripping device 1, and the control device 103 has a third operation mode that adjusts a distance between the suction section 10 and the support section 20, before the suction section 10 sucks the target object 4. With this configuration, the distance between the suction section 10 and the support section 20 can be adjusted according to the height dimension of the target object 4, thereby optimizing the pick-up operation.

### Third Example Embodiment

Next, a third example embodiment of the present invention will be described. In the following description, the same or equivalent configurations as those of the above-mentioned example embodiments are given the same reference numerals, and their description will be simplified or omitted.

FIG. 16 to FIG. 18 are explanatory diagrams illustrating the pick-up operation of the conveyance system 100 according to the third example embodiment.

As shown in these figures, the third example embodiment differs from the above-mentioned example embodiments in that it has a second operation mode in which, after the pick-up operation of the first example embodiment described above (more specifically, the first operation mode), the suction state of the suction section 10 is released, and the support section 20 on which the target object 4 is placed is moved in a direction along the suction surface 10A, to adjust the suction position of the suction section 10 relative to the target object 4.

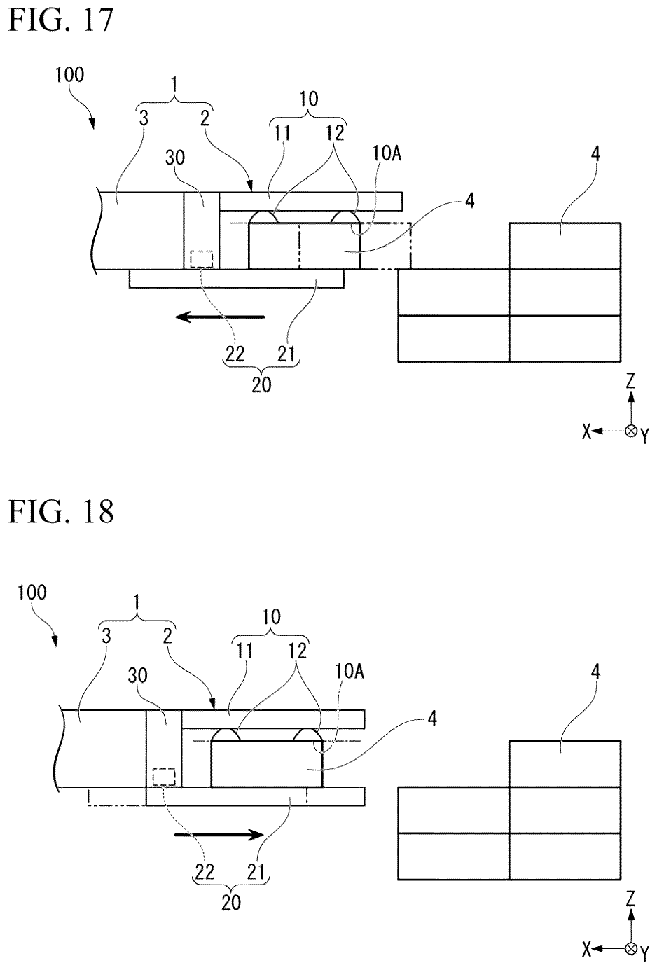

The process up to the pick-up operation shown in FIG. 16 is the same as in the first example embodiment. What is distinctive is that after pick-up, as shown in FIG. 17, the suction section 10 releases the suction of the target object 4, and the target object 4 is slid (moved in the +X direction in the example of FIG. 17) while placed on the support section 20. Thereafter, the target object 4 is again sucked by the suction section 10, and as shown in FIG. 18, the support section 20 is slid (moved in the −X direction in the example of FIG. 18) to return to its original position.

In this way, in the third example embodiment, the control device 103 has a second operation mode in which, after the first operation mode, the suction state of the suction section 10 is released, and the support section 20 on which the target object 4 is placed is moved in a direction along the suction surface 10A, and the suction position of the suction section 10 relative to the target object 4 is adjusted. According to this configuration, even if the gap S1 shown in FIG. 2 is narrow and only the front end of the target object 4 can be gripped (for example, as shown in FIG. 16, when the target object 4 is sucked by one suction pad 12 in side view), the suction position of the target object 4 can be adjusted and the target object can be re-sucked after picking up the target object 4 (for example, as shown in FIG. 18, when the target object 4 is stably gripped by two suction pads 12 in side view). Therefore, it is possible to prevent the target object 4 from falling during transportation.

Note that the above-mentioned example embodiments may adopt the following modified example.

For example, although one gripping device 1 is mounted on the autonomous mobile cart 102 shown in FIG. 2, multiple gripping devices 1 may be mounted on the autonomous mobile cart 102.

The example embodiments of the present invention have been described above in detail with reference to the drawings, however the specific configuration is not limited to these example embodiments, and design changes within the scope of the present invention are also included.

### DESCRIPTION OF REFERENCE SIGNS

1 Gripping device
2 Hand part
3 Arm part
4 Target object
5 Rack
6 Shelf
7 Tray
10 Suction section
10A Suction surface
11 First flat plate
11a Main body part
11b Tip part
11c Tapered section
12 Suction pad
20 Support section
21 Second flat plate
22 Slide mechanism
30 Connection section
40 Gap adjustment unit
100 Conveyance system
101 Lifter
102 Autonomous mobile cart
103 Control device
D1 Spacing
D2 Spacing
H1 Dimension
S1 Gap
W1 Width
W2 Width

What is claimed is:

1. A gripping device comprising:
a hand part that grips an object; and
an arm part that is connected to the hand part and moves the hand part,
wherein the hand part includes:
a suction section that has a suction surface sucking the object; and
a support section that is movable along the suction surface relative to the suction section.

2. The gripping device according to claim 1, wherein at least one of the suction section or the support section includes a flat plate shape.

3. The gripping device according to claim 1, wherein at least one of the suction section or the support section includes a flat plate shape,
wherein one end of the suction section includes a convex shape, and
wherein the one end of the suction section is an end opposite to another end to which the arm part is connected.

4. The gripping device according to claim 1, wherein at least one of the suction section or the support section includes a flat plate shape,
wherein corners of one end of the suction section are rounded, and
wherein the one end of the suction section is an end opposite to another end to which the arm part is connected.

5. The gripping device according to claim 1, wherein the hand part includes a gap adjustment unit that adjusts a distance between the suction section and the support section, in a direction perpendicular to the suction surface.

6. A conveyance system comprising:
the gripping device according to claim 1; and
a control device configured to control the gripping device,
wherein the control device has a first operation mode in which, while the suction section moves along the suction surface while sucking the object, the support section is moved relatively in a direction opposite to a moving direction of the suction section to place the object on the support section.

7. The conveyance system according to claim 6, wherein in the first operation mode, while the suction section moves in the moving direction of the suction section while sucking the object, the support section is moved at a same speed as a moving speed of the suction section to place the object on the support section.

8. The conveyance system according to claim 6, wherein the control device has a second operation mode in which, after executing the first operation mode, the suction section releases the object from sucking the object and the support section is moved in the direction to the moving direction of the suction section to adjust a suction position of the object for the suction section.

9. A conveyance system comprising:
the gripping device according to claim 5; and
a control device configured to control the gripping device,
wherein the control device has a third operation mode in which, a distance between the suction section and the support section is adjusted, before the suction section sucks the object.
